(19) United States
(12) Patent Application Publication
(10) Pub. No.: US 2004/0160061 A1
(43) Pub. Date: Aug. 19, 2004

(54) Gas-turbine engine with catalytic reactor

(75) Inventors: Gregory C. Rouse, Westlake Village, CA (US); Douglas A. Hamrin, Studio City, CA (US); Guillermo Pont, Los Angeles, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Capstone Turbine Corporation

(21) Appl. No.: 10/355,142

(22) Filed: Jan. 31, 2003

(51) Int. Cl. H02P 9/04

(52) U.S. Cl. 290/52

(57) ABSTRACT

The present invention provides a gas-turbine engine and a combustion system that include a catalytic reactor and a turbine. The catalytic reactor oxidizes low BTU fuel to generate thermal energy. The turbine converts the thermal energy produced by the catalytic reactor into mechanical energy. This mechanical energy can be used, for example, to produce electricity. The gas-turbine engine and the catalytic combustion system are capable of oxidizing fuels having a higher heating value in a range of between 1000 and 5 BTU/scf.

### FIELD OF THE INVENTION

The present invention relates to a gas-turbine engine. More particularly, it relates to a gas-turbine engine having a catalytic reactor.

### BACKGROUND OF THE INVENTION

A gas-turbine engine converts fuel and air into thermal and mechanical energy. In the electric power industry, for example, this mechanical energy is used to power an electric generator and produce electricity.

Conventional gas-turbine engines have limitations. Among others, these limitations include an inability to operate using low BTU fuels and the production of unwanted emissions. Complex fuel delivery systems, combustion systems, and emission control systems have been developed for the conventional gas-turbine engines in an attempt to overcome these limitations. These systems are expensive, and they do not completely compensate for the limitations.

What is needed is a gas-turbine engine that does not have all of the limitations of the conventional gas-turbine engines.

### BRIEF SUMMARY OF THE INVENTION

The present invention provides a gas-turbine engine and a combustion system that include a catalytic reactor and a turbine. The catalytic reactor oxidizes fuel consumed by the catalytic combustion system to release thermal energy. The turbine converts the thermal energy released by the catalytic reactor into mechanical energy. This mechanical energy can be used, for example, to produce electricity.

In addition to the catalytic reactor and the turbine, the catalytic combustion system includes a compressor, a pre-heater, and a recuperator. The compressor is used to increase the pressure of air or a fuel-air mixture prior to oxidation by the catalytic reactor. The pre-heater and the recuperator are used to add energy to the air or the fuel-air mixture prior to oxidation by the catalytic reactor. A control system is used to vary the fuel-air mixture ingested by the catalytic reactor.

A motor-generator is mechanically coupled to the turbine. The motor-generator is used to control the speed of the turbine and to generate electricity. A bi-directional power converter is electrically coupled between the motor-generator and a DC bus. A control system coupled to the bi-directional power converter controls the flow of power between the motor-generator and the DC bus.

The catalytic combustion system is capable of oxidizing a fuel having a higher heating value in a range of between 1000 and 100 BTU/scf. In other embodiments, the catalytic combustion system is capable of oxidizing a fuel having a higher heating value in a range of between 100 and 15 BTU/scf. In still other embodiments, the catalytic combustion system is capable of oxidizing a fuel having a higher heating value in a range of between 30 and 5 BTU/scf. These ranges are by way of example only. Other embodiments are capable of oxidizing fuels having different higher heating values. As used herein, the term “heating value” means the amount of energy released when a fuel is burned completely in a steady-flow process and the products are returned to the state of the reactants. The actual “heating value” obtained is dependent on the phase of the H₂O (water/steam) in the combustion products. If the H₂O is in liquid form, the heating value obtained is called “higher heating value” (HHV). If the H₂O is in vapor form, the heating value obtained is called “lower heating value” (LHV).

Further embodiments, features, and advantages of the present invention, as well as the structure and operation of the various embodiments of the present invention are described in detail below with reference to the accompanying drawings.

### BRIEF DESCRIPTION OF THE DRAWINGS

The present invention is described with reference to the accompanying figures. In the figures, like reference numbers indicate identical or functionally similar elements. Additionally, the left-most digit or digits of a reference number identify the figure in which the reference number first appears. The accompanying figures, which are incorporated herein and form part of the specification, illustrate the present invention and, together with the description, further serve to explain the principles of the invention and to enable a person skilled in the relevant art to make and use the invention.

FIG. 1 is a block diagram of a catalytic combustion system employed with the invention.

FIG. 2 is a block diagram of a gas-turbine engine.

FIG. 3 is a more detailed block diagram of a catalytic combustion system.

FIG. 4 illustrates a gas-turbine engine.

FIGS. 5A-B illustrate a cross-section of a compressor and a mixing zone.

FIG. 6 illustrates a catalytic reactor.

FIG. 7 illustrates a recuperator and a pre-heater.

FIG. 8 is a schematic diagram of a fuel-air control system.

FIG. 9 is a flowchart of a method for starting up the combustion system.

FIG. 10 is a flowchart of a method for controlling the fuel delivery rate of the combustion system during start-up.

FIG. 11 is a graph illustrating a start-up sequence for the combustion system.

FIG. 12 is a flowchart of a method for normal fuel control in a moderate BTU combustion system having a fuel control value.

FIG. 13 is a flowchart of a method for normal fuel control in a low BTU combustion system having an air control value.

FIG. 14 is a flowchart of a method for normal fuel control in an ultra low BTU combustion system having no fuel control valve and no an air control value.

FIG. 15 is a block diagram illustrating how to calculate fuel concentration for a combustion system without a fuel value.

FIG. 16 is a graph illustrating temperature rise as a function of time and power level for the combustion system.

### DETAILED DESCRIPTION OF THE INVENTION

Introduction

The present invention provides a gas-turbine engine and a combustion system that include a catalytic reactor. Engines and systems according to the present invention have many features and advantages including, but not limited to, variable speed operation, ease of installation and operation, low maintenance requirements, ability to bum a wide range of low BTU fuels, low emissions, and capability of sustained catalytic combustion over a wide range of operating power levels.

As noted above, it is a feature of engines and systems according to the present invention that they are capable of sustained catalytic combustion over a wide range of operating power levels. For sustained catalytic combustion, the operating temperature of a gas-turbine engine should preferably remain within a limited band of operating temperatures over a wide range of operating power levels. A typical band of catalytic reactor operating temperatures is approximately between 800° F. and 1100° F. However, for conventional gas-turbine engines, operating temperature is a function of power level. Thus, when conventional gas-turbine engines operate at part load, they typically reduce their operating temperature while maintaining a constant engine speed. This reduction of operating temperature causes the operating temperature of the conventional gas-turbine engines to fall outside the limited band of catalytic reactor operating temperatures. Unlike known constant-speed gas-turbine engines, gas-turbine engines according to the invention adjust their engine speed with power level to maintain a nearly constant operating temperature over a wide range of operating power levels.

In addition to adjusting engine speed with power level to maintain a nearly constant operating temperature, gas-turbine engines and systems according to the present invention have recuperators and pre-heaters that help maintain the minimum operating temperature needed for sustained catalytic combustion, even during periods of fuel interruption. Recuperators and pre-heaters are not typically used with known fixed speed gas-turbine engines having relatively high compression ratios exceeding about 8:1.

It is a further, feature of engines and systems according to the present invention that fuel can be injected into these engines and systems at the compressor inlet. Thus, there is no need for complex or high-pressure fuel delivery systems having fuel gas compression. In fact, in some embodiments, no fuel-metering valve is needed, as controlling the speed of the gas-turbine engine can control the fuel flow to the engine.

These and other features and advantages of the present invention will now be described in detail with reference to the accompanying drawings.

Example Engines and Systems According to the Invention

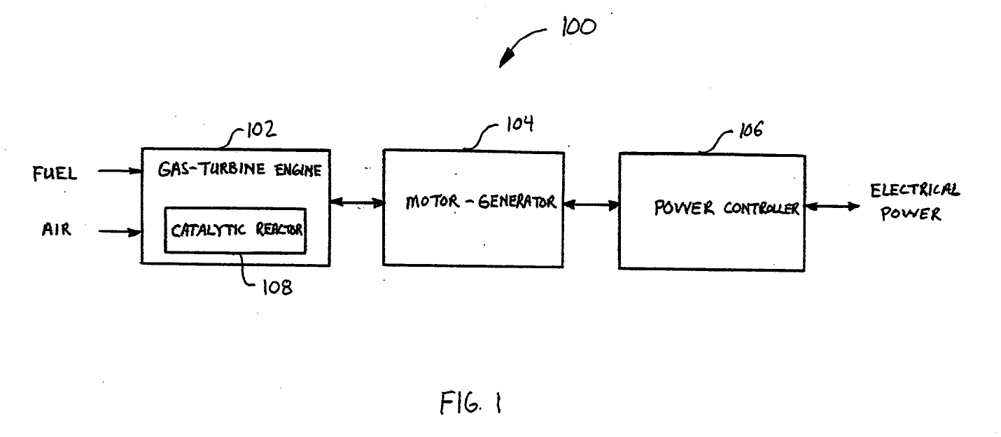

FIG. 1 is a block diagram of a catalytic combustion system 100 according to the invention. System 100 includes a gas-turbine engine 102, a motor-generator 104, and an electrical power controller 106. As illustrated in FIG. 1, gas-turbine engine 102 includes a catalytic reactor 108.

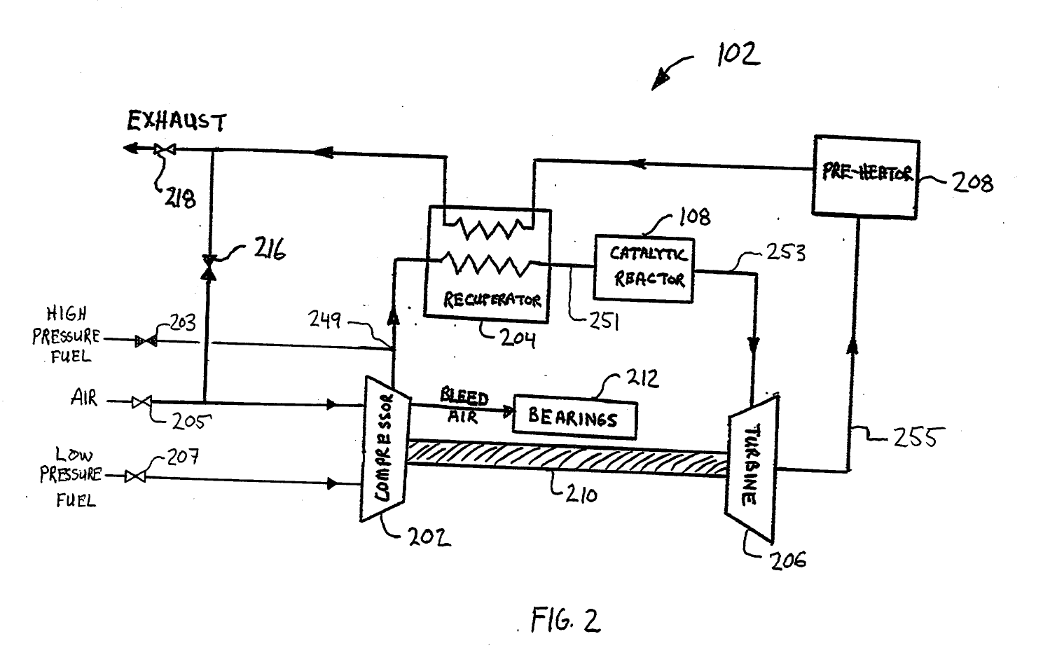

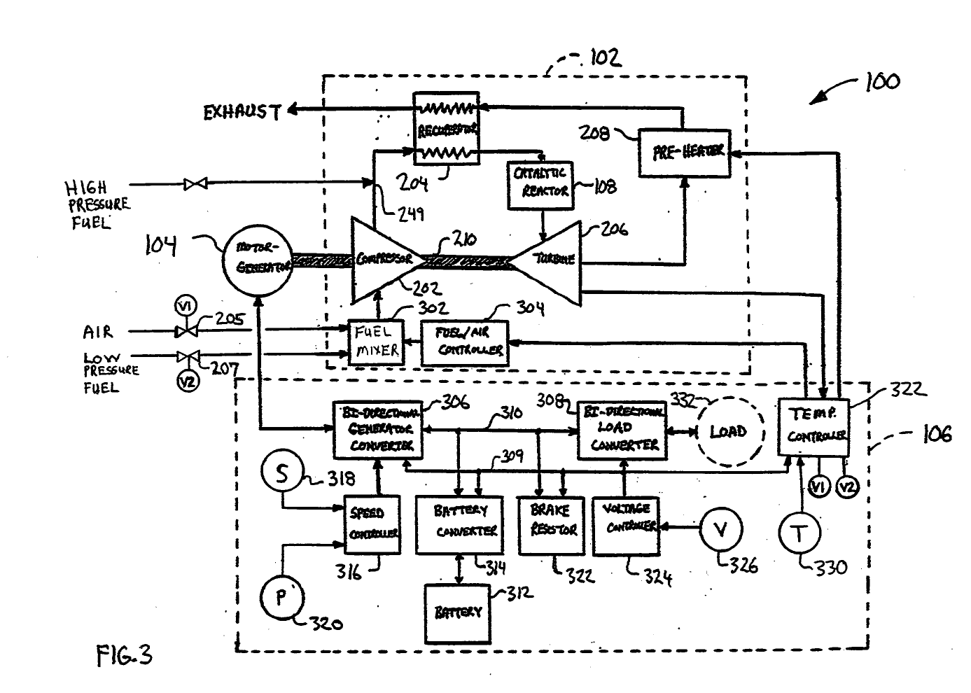

Gas-turbine engine 102 consumes fuel and combustion air to produce mechanical energy. Gas-turbine engine 102 is capable of sustained catalytic combustion over a wide range of operating power levels. Unlike known constant-speed gas-turbine engines, the engine speed of gas-turbine engine 102 is varied with power level to maintain a narrow band of operating temperatures or a nearly constant operating temperature. This narrow band of operating temperatures or nearly constant operating temperature condition allows catalytic reactor 108 to continue operating regardless of the operating power level of gas-turbine engine 102. The features and operation of gas-turbine engine 102 as well as catalytic reactor 108 are further described below with reference to FIG. 2 and FIG. 3.

Motor-generator 104 is mechanically coupled to gas-turbine engine 102. Motor-generator 104 is used both to motor gas-turbine engine 102, and thereby start or control/adjust the speed of gas-turbine engine 102, and to convert the mechanical energy of gas-turbine engine 102 to electrical energy. Motor-generator 104 may have a permanent magnet rotor (not shown), as would be known to persons skilled in the relevant art. One example of a known type of motor-generator applicable to the system of the present invention is shown in commonly owned U.S. Pat. No. 5,903,116, which is incorporated herein by reference in its entirety. The features and operation of gas-turbine engine 102 are further described below with reference to FIG. 3.

Power controller 106 is electrically coupled to motor-generator 104.

Power controller 106 serves many functions. For example, power controller 106 couples the electric output of motor-generator 104 to a load. This load may be either a stand-alone load (not shown) or a utility grid (not shown).

Power controller 106 is also used to start-up gas-turbine engine 102. Other functions performed by power controller 106 include, for example, controlling the flow of power to and from motor-generator 104, transforming and conditioning the electrical power generated by motor-generator 104, and controlling operating transients experienced by system 100. The features and operation of power controller 106 are further described below with reference to FIG. 3.

Among other features and advantages, gas-turbine engine 102 has low maintenance requirements, it can burn a wide range of low BTU fuels, and it has low emissions. In certain embodiments of this invention, the gas-turbine engine 102 is capable of oxidizing a fuel having a higher heating value in a range of between 1000 and 100 BTU/scf. In other embodiments, the gas-turbine engine 102 is capable of oxidizing a fuel having a higher heating value in a range of between 100 and 15 BTU/scf. In still other embodiments, the gas-turbine engine 102 is capable of oxidizing a fuel having a higher heating value in a range of between 30 and 5 BTU/scf. These ranges are by way of example only, as other embodiments of the present invention are capable of oxidizing fuels having different higher heating values.

FIG. 2 is a block diagram of gas-turbine engine 102. Gas-turbine engine 102 includes a compressor 202, a recuperator 204, catalytic reactor 108, a turbine 206, and a pre-heater 208. Compressor 202 and turbine 206 are coupled to a shaft 210. Shaft 210 is supported by bearings 212. Fuel flow may be controlled by valves 203 and/or 205. In one embodiment, no valve is required to control fuel or air flow. Bleed air may be used to operate and/or cool bearings 212.

The components of gas-turbine engine 102 are as follows. The compressor 202 is a one-stage, centrifugal flow compressor. The recuperator 204 is a metallic, counter flow, primary surface type heat exchanger. The catalytic reactor 108 is a high-temperature, low emissions catalytic reactor.

The turbine 206 is a one-stage radial inflow turbine. The pre-heater 208 is an electric heater or a gas flame or another source of heat. The bearings 212 are air bearings that operate free of contact with the shaft 210. These components are by way of example only and are not intended to limit the invention. Other components can be used in place of these components without deviating from the invention.

The operation of gas-turbine engine 102 will now be described with reference to the components illustrated in FIG. 2.

During operation, fuel and air are mixed together to form a fuel-air mixture having a desired fuel-air ratio. The pressure of the fuel-air mixture is increased to a desired pressure by compressor 202. The temperature of the fuel-air mixture is increased to at least the minimum operating temperature of catalytic reactor 108 using recuperator 204. Recuperator 204 transfers thermal energy from exhaust gasses of gas-turbine engine 102 to the fuel-air mixture, thereby increasing the temperature of the fuel-air mixture. Catalytic reactor 108 substantially oxidizes the fuel present in the fuel-air mixture and produces heated exhaust gasses. The exhaust gasses from catalytic reactor 108 expand across turbine 206 and cause turbine 206 to rotate. The exhaust gasses exiting turbine 206 pass through recuperator 204 and are exhausted from gas-turbine engine 102.

During periods of operation, when the exhaust gasses exiting turbine 206 are below a desired temperature such as, for example, during the start-up of the gas-turbine engine 102, pre-heater 208 is used to increase the temperature of the exhaust gasses before they enter recuperator 204. In addition, valves 216 and 218 can be aligned to recirculate the exhaust gasses during start-up to the inlet of compressor 202. Either the entire exhaust gas flow or some portion thereof can be recirculated. Recirculating the exhaust gasses reduces pre-heater energy input by providing preheated combustion air recovered during start-up that would otherwise be vented to the atmosphere.

Once the temperature of the air entering catalytic reactor 108 reaches a minimum Ioperating temperature (e.g., the temperature at which catalytic reactor 108 would begin effectively oxidizing any entering fuel-air mixture), valves 216 and 218 can be realigned to vent some or all of the recirculated exhaust gasses to the atmosphere.

Fuel and air (combustion air) are mixed together to form a fuel-air mixture which is introduced into the inlet of compressor 202. An advantage of this arrangement is that there is no requirement for a complex, high-pressure fuel delivery system. The amount of combustion air mixed together with the fuel is sufficient to completely oxidize the fuel. A fuel valve is typically used to control the fuel-air ratio in embodiments designed to use fuels having higher heating values in the range of between 1000 and 100 BTU/scf. An air valve is typically used to control the fuel-air ratio in embodiments designed to use fuels having higher heating values in the range of between 100 and 15 BTU/scf. In embodiments designed to use fuels having higher heating values in the range of between 30 and 5 BTU/scf, no valve is needed to control the fuel-air ratio. In these embodiments, the speed of gas-turbine engine 102 controls fuel flow.

In other embodiments, only combustion air is introduced into the inlet of compressor 202. In these embodiments, the high-pressure fuel is injected into the compressed combustion air exiting compressor 202. The pressure of the fuel injected into the compressed air must be greater than the pressure of the compressed air. An advantage of these embodiments is that no fuel will be present in any bleed air tapped from the compressor 202. In some embodiments, fuel is injected into the high-pressure exit 251 of the recuperator 204.

Recuperator 204 is used to transfer thermal energy from the exhaust gasses of gas-turbine engine 102 to the fuel-air mixture prior to the fuel-air mixture entering catalytic reactor 108. The transferred thermal energy raises the temperature of the fuel-air mixture above the minimum operating or start-up temperature of the catalytic reactor 108.

Catalytic reactor 108 oxidizes or bums the fuel-air mixture and produces exhaust gasses to drive turbine 206. The operating temperature of catalytic reactor 108 varies depending on the material and catalytic substrate used to construct catalytic reactor 108. Catalytic reactor 108 is able to oxidize/bum various fuels including mixtures and dilute mixtures including one or more of the fuels listed below in Table 1. As described herein, catalytic reactor 108 is preferably a high-temperature catalytic reactor that produces little or no NOₓ or CO gasses. Such catalytic reactors are available, for example, from Süd-Chemie Prototech, Inc., 32 Fremont Street, Needham, Mass. 02494.

TABLE 1

| Gas | LEL V/V % | HEL V/V % | Ignition Temp ° F. |
|---|---|---|---|
| Methane | 5.0 | 15 | 990 |
| Propane | 2.1 | 9.5 | 840 |
| Butane | 1.9 | 8.5 | 550 |
| Natural Gas | 3.8 | 17 | 900 |
| Carbon Monoxide | 12.5 | 74 | 1128 |
| Ethane | 3.0 | 12.5 | 880 |
| Hydrogen | 4.0 | 75 | 930 |

Turbine 206 is designed to operate in a range of between 45,000 rpm and 96,000 rpm. The speed of turbine 206 is a function of the output power level of gas-turbine engine 102. Turbine 206 produces sufficient mechanical power to drive, for example, a 30 kw, a 60 kw, a 100 kw, or a 200 kw electric generator. These values are by way of example only. Other embodiments have turbines capable of driving other generators.

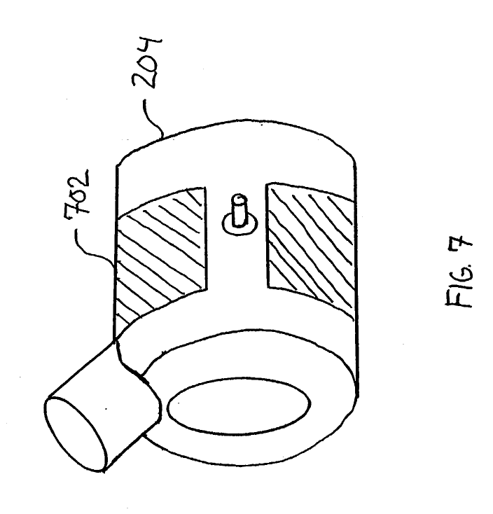

As noted above, pre-heater 208 maybe an electric heater, a gas flame, or another suitable heat source. Pre-heater 208 can be placed in the flow stream, upstream of the catalytic reactor 108 at 251, downstream of the catalytic reactor 108 at 253, or downstream of turbine 206 at 255 to directly heat the working fluid. Alternatively, pre-heater 208 can be coupled to a component, through which the exhaust gasses flow, to indirectly heat the exhaust gasses. In one embodiment, pre-heater 208 is an electric band heater 702 (see FIG. 7) wrapped around recuperator 204. This embodiment takes advantage of the heat transfer area of recuperator 204 to heat the exhaust gasses and fuel-air mixture. In addition, this embodiment has the advantage that it does not impose an additional pressure drop that can be imposed by an electric heating element or a fuel injector when these items are placed in the exhaust flow stream to heat the exhaust gasses. In another embodiment, pre-heater 208 may be embedded in recuperator 204. In a further embodiment, catalytic reactor 108 is directly heated using, for example, an electric heater.

As described herein, a pre-heater 208 located downstream of the catalytic reactor 108 at 253 or 255 has the advantage that any hot streaks from the pre-heater do not pass through the catalytic reactor. Pre-heater hot steaks therefore will not have detrimental effects on the catalyst of catalytic reactor 108. These embodiments of pre-heater 208 can, if fired, utilize gaseous or liquid fuels.

As illustrated in FIG. 2, compressor 202 and turbine 206 are coupled to a single shaft 210. Shaft 210 is supported by bearings 212. Bearings 212 include a radial bearing and a bilateral thrust bearing. These bearings are preferably air bearings that may be operated and/or cooled by bleed air from compressor 202. Air bearings do not require conventional oil lubrication, and thus have lower maintenance requirements and higher reliability than other types of bearings. Other bearings, including conventional oiled bearings, can be used.

FIG. 3 is a more detailed block diagram of catalytic combustion system 100 according to the invention. Each of the subsystems of catalytic combustion system 100 discussed above with respect to FIG. 1, namely gas-turbine engine 102, motor-generator 104, and power controller 106, is shown in FIG. 3.

As illustrated in FIG. 3, the components of gas-turbine engine 102 include compressor 202, recuperator 204, catalytic reactor 108, turbine 206, pre-heater 208, a fuel mixer 302, and a fuel-air controller 304. With the exception of the fuel mixer 302 and fuel-air controller 304, each of these components and its operation is described above with reference to FIG. 2.

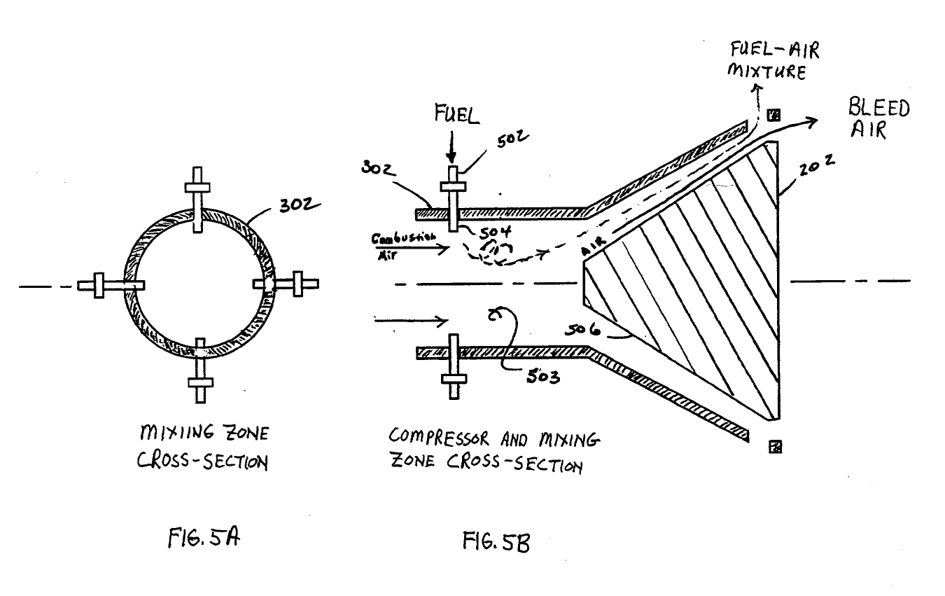

Fuel mixer 302 is a static mixer design as illustrated in more detail in FIGS. 5A-B. Combustion air enters fuel mixer 302 at a rate determined, for example, by the operating speed of gas-turbine engine 102. Fuel is injected into fuel mixer 302 and mixed with the incoming combustion air to produce a fuel-air mixture. The mass flow rate of the combustion air and the mass flow rate of the fuel determine the fuel-air ratio of the fuel-air mixture. As noted herein, in other embodiments, the fuel is injected at other locations such as, for example, after compressor 202.

Fuel mixer 302 is preferably designed so that the fuel-air mixture exiting a mixing zone is below an explosive limit of the fuel and so that the peak fuel concentration that comes into contact with any potential ignition sources within gas-turbine engine 102 (e.g., generator windings, bearings, or compressor shroud) is below a flammability limit of the fuel. Fuel mixer 302 is also preferably designed to have a geometry that prevents more than an insubstantial amount of fuel (e.g., 10-100 PPM) from entering a flow streamline used for extracting bleed air (See FIG. 5B).

Fuel-air controller 304 is coupled to fuel mixer 302. Fuel-air controller 304 controls either the mass flow rate of the fuel, the mass flow rate of the combustion air, or both. Fuel-air controller 304 typically opens and closes a fuel valve 203 and or 207 to adjust and vary the fuel-air ratio in embodiments designed to use fuels having higher heating values in the range of between 1000 and 100 BTU/scf. Fuel-air controller 304 typically opens and closes an air valve 205 to adjust and vary the fuel-air ratio in embodiments designed to use fuels having higher heating values in the range of between 100 and 15 BTU/scf. In embodiments designed to use fuels having higher heating values in the range of between 30 and 5 BTU/scf, the fuel or air valve may not be needed to control the fuel-air ratio.

Fuel-air controller 304 receives an input from a temperature controller 328. This input allows the fuel-air controller 304 to make automatic adjustments to the fuel-air ratio based on the operating temperature of the gas-turbine engine 102.

Still referring to FIG. 3, power controller 106 comprises a bi-directional generator converter 306, a bi-directional load converter 308, and a DC bus 310. Bi-directional generator converter 306 is coupled to the motor-generator 104 and DC bus 310. Bi-directional load converter 308 is coupled to DC bus 310 and to a load 332. Bi-directional generator converter 306 and the bi-direction load converter 308 together control the flow of electrical power between motor-generator 104 and load 332.

Power controller 106 also includes a battery 312 and a bi-directional battery converter 314. Battery 312 is coupled to battery converter 314. Bi-directional battery converter 314 is coupled to DC bus 310. Bi-directional battery converter 314 controls the flow of electrical power between battery 312 and DC bus 310.

Power controller 106 includes a speed controller 316. Speed controller 316 is coupled to bidirectional generator controller 306. Speed controller 316 is used to operate bi-directional generator converter 306 and adjust and vary the speed of motor-generator 104, for example, during start-up of system 100 or during changes in the operating power level of system 100. Speed controller 316 receives an input speed control signal 318 (e.g., speed set point signal) and/or an input power control signal 320 (e.g., power set point signal).

Power controller 106 includes a brake resistor 322. Brake resistor 322 is coupled to DC bus 310. Brake resistor 322 is used to dissipate excess power generated by motor-generator 104 and to control the voltage of DC bus 310 during certain operating transients (e.g., when any excess power generated by motor-generator 104 cannot be absorbed and stored by battery 312). In operation, when the voltage on DC bus 310 rises above a predetermined voltage level, brake resistor 322 is turned on and is used to absorb and dissipate energy.

The energy dissipated by brake resistor 322 may be transferred to the exhaust gasses of gas-turbine engine 102 (e.g., the brake resistor is used in a manner similar to that of pre-heater 208). This is particularly useful in stand- alone power supply applications. Conversely, pre-heater 208 can be used to fulfill the function of brake resistor 322. When rapid load reduction is required by system 100, the load can be transferred to pre-heater 208. In this situation, a portion of the electrical energy generated by motor-generator 104 is converted to thermal energy and recovered by system 100 using recuperator 204. This embodiment of the invention allows the catalytic reactor 108 to be kept at operating temperature while load is being taken off the system 100. In a variation of this embodiment, gas-turbine engine 102 is run at a constant speed, and brake resistor 322 and/or pre-heater 208 is used to dissipate excess power from system 100 during partial loads. In this embodiment, recuperator 204 is used to recover at least some of the energy dissipated by brake resistor 322 or pre-heater 208, thereby reducing the amount of fuel (input energy) required at partial loads. This embodiment is also particularly useful for standalone operation of system 100 because it can instantaneously adjust power supplied to load 332.

Power controller 106 includes a voltage controller 324. Voltage controller 324 is coupled to bi-directional generator controller 306, bi-directional load controller 308, bi-directional battery converter 314, and/or brake resistor 322, if these elements are present. Voltage controller 324 is used to operate these components of system 100 and thereby control the voltage level of DC bus 310. Voltage controller 324 receives an input voltage control signal 326 (e.g., voltage set point signal).

Power controller 106 also includes a temperature controller 328 that controls the operating temperature of gas-turbine engine 102. Temperature controller 328 is coupled to fuel-air controller 304 and pre-heater 208. Temperature controller 328 receives an input temperature signal for the exhaust gasses exiting turbine 206. Temperature controller 328 also receives an input temperature control signal 330 (e.g., temperature set point signal). Temperature controller 328 turns-on and turns-off pre-heater 208 and controls, for example, the opening and closing of a fuel valve 203 and/or a fuel valve 207 and/or an air valve 205, if present.

A more detailed description of an appropriate power controller 106 is disclosed in commonly owned U.S. Pat. No. 6,487,096 B1. The disclosure of U.S. Pat. No. 6,487,096 B1 is incorporated herein in its entirety by reference as though set forth in full hereafter.

Catalytic combustion system 100 illustrated in FIG. 3 has three substantially decoupled control loops. These three control loops control (1) the operating temperature of gas-turbine engine 102, (2) the rotary speed of gas-turbine engine 102 and motor generator 104, and (3) the operating voltage of DC bus 310. These three control loops will now be described with reference to the components of system 100 illustrated in FIG. 3.

A first control loop controls the operating temperature of gas-turbine engine 102. This control loop is implemented, in part, by temperature controller 328. Temperature controller 328 regulates a temperature related to the desired operating temperature of catalytic reactor 108 to a set point (e.g., temperature control signal 330). This is achieved, for example, by varying fuel flow to catalytic reactor 108. Temperature controller 328 receives a temperature control signal 330, or set point T, and a measured temperature from a temperature sensor (not shown) connected, for example, to an exhaust gas outlet of turbine 206. Temperature controller 328 generates and transmits a fuel control signal to fuel-air controller 304. The fuel control signal controls the amount of fuel supplied to catalytic reactor 108 by fuel mixer 302. The fuel is controlled to an amount intended to result in a desired operating temperature in catalytic reactor 108. A temperature sensor (not shown) may directly measure the temperature of catalytic reactor 108 or may measure a temperature of an element or area from which the temperature of catalytic reactor 108 can be inferred. The speed of the temperature control loop is about 100 ms.

A second control loop, controlled in part by speed controller 316, controls the speed of shaft 210. Shaft 210 is common to turbine 206, compressor 202, and motor-generator 104. Speed is varied by varying the torque applied by motor-generator 104 to common shaft 210. The torque applied by motor-generator 104 to common shaft 210 depends upon power or current drawn from or pumped into windings of motor-generator 104. Bi-directional generator converter 306 is controlled by speed controller 316 to transmit power or current into or out of motor-generator 104. A sensor (not shown) in motor-generator 104 or gas-turbine engine 102 senses the rotary speed on common shaft 210 and transmits that rotary speed signal to speed controller 316. Speed controller 316 receives the rotary speed and compares it to speed control signal 318. Speed controller 316 generates and transmits to bidirectional generator converter 306 a control signal which controls the operation of bidirectional generator converter 306 and the transfer of power or current between motor-generator 104 and DC bus 310. Speed control signal 318 may be formed or derived from power control signal 320. The speed of the speed control loop is about 20 ms.

A third control loop, controlled in part by voltage controller 324, controls bus voltage on DC bus 310 to a set point (e.g., voltage control signal 326). This control is achieved by transferring power between motor-generator 104 and any of load 332, battery 312, brake resistor 324, and pre-heater 208. A sensor (not shown) measures voltage on DC bus 310 and transmits a measured voltage signal to voltage controller 324. Voltage controller 324 receives the measured voltage signal and compares it to a voltage set point V (e.g., voltage control signal 326). Voltage controller 324 generates and transmits signals to bidirectional generator converter 306, bidirectional load converter 308, brake resistor 322, and bi-directional battery converter 314, thereby controlling the transmission of power from motor-generator 104 to load 332, brake resistor 322, and battery 312, respectively. This control of power flow controls the voltage of DC bus 310. The speed of the power control loop is about 500 ms.

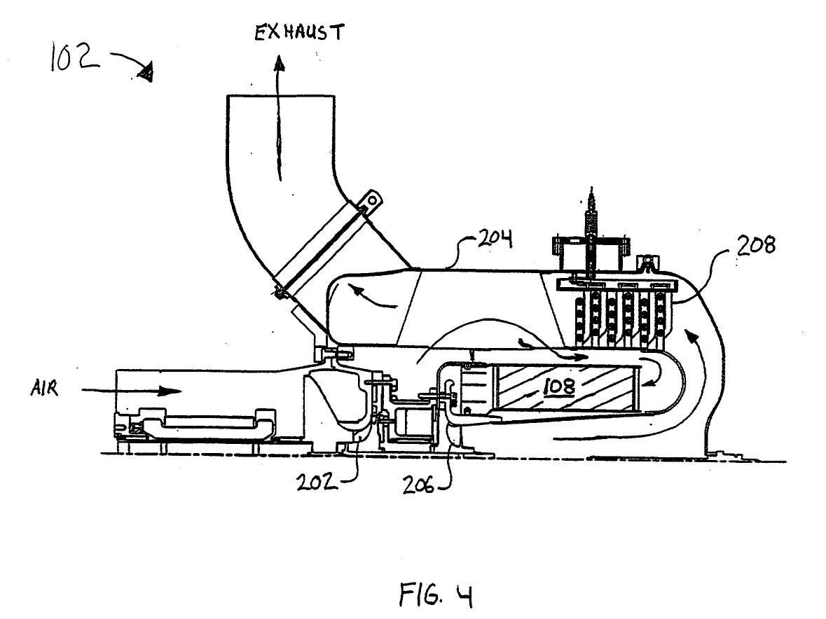

FIG. 4 illustrates a cut-away sectional view of a gas-turbine engine 102. Illustrated in FIG. 4 are example embodiments of compressor 202, recuperator 204, catalytic reactor 108, and pre-heater 208. In the embodiment illustrated in FIG. 4, pre-heater 208 is an electric pre-heater that is located in the flow stream of the turbine exhaust gasses upstream of the recuperator heat exchanger surface.

FIGS. 5A-B illustrate an example fuel mixer 302 and an example compressor 202 having a hub line 506. The example fuel mixer 302 includes fuel lines 502 coupled to injectors 504. Fuel is injected into fuel mixer 302 using fuel lines 502 and injectors 504 to form a fuel-air mixture. Four injector-fuel line assemblies are shown, however, one or more may be used in practice to assure good mixing. The zone downstream of injectors 504 is the mixing zone 503. Adequate mixing of fuel and air is accomplished when mixing zone 503, injector geometry 504, injector location, and injector quantity provide sufficient turbulence. Mixing may also be enhanced by structures (not shown) located within or adjacent to the mixing zone that promote turbulence.

As illustrated by FIG. 5B, injector 504 is preferably placed into the combustion air flow stream at a pre-selected depth so that no fuel is present in the air flow stream traveling along hub 506 of compressor 202. This placement minimizes or eliminates the presence of unburned fuel in any bleed air drawn from the compressor 202. The depth that injector 504 is placed into the combustion air flow stream is adjustable.

In addition to adjusting the depth of injector 504 into the combustion air flow stream of fuel mixer 302, the following two approaches can be implemented to reduce or eliminate any unburned fuel in gas-turbine engine 102. These two approaches are only illustrative, and they are not intended to limit the invention.

First, since most of the unburned fuel will likely go into a secondary air flow used for bearing cooling and thrust balancing, and eventually end up in a cavity in the center housing region of gas-turbine engine 102, this cavity can be evacuated. Evacuation can be achieved by installing a bleed circuit from this cavity to a location outside the gas-turbine engine 102. Typically, the pressure in the cavity will be higher than ambient pressure establishing the desired bleed flow. The gas that is bled off from the cavity may be re-introduced at the inlet of gas-turbine engine 102 for complete oxidation.

Second, a low activation temperature catalyst (not shown) can be added to the surfaces of the low-pressure/turbine exhaust side of recuperator 204 to reduce or eliminate unburned fuel. This catalyst would oxidize any unburned fuel downstream of turbine 206. In addition, it would help heat the gas on the high-pressure side of recuperator 204 and improve the efficiency of gas-turbine engine 102.

As noted herein, injecting the fuel into the inlet of compressor 202 ensures that the fuel is well mixed with the combustion air prior to reaching catalytic reactor 108. In the case of liquid fuels, the recuperator ensures the fuel is vaporized prior to reaching catalytic reactor 108. For safety reasons, the fuel-air mixture formed should not be flammable. This will ensure that any unwanted sparks caused, for example, by a compressor rub will not ignite the fuel-air mixture.

Fuel may be injected at the discharge of compressor 202. In such embodiments, a compressor discharge cavity (not shown) and recuperator 204 ensure the fuel and the combustion air are well mixed prior to reaching catalytic reactor 108. As noted above, recuperator 204 helps ensure the liquid fuel is vaporized prior to reaching catalytic reactor 108.

Injecting high-pressure liquid fuel downstream of compressor 202 at location 249 is preferable to injecting gaseous fuels downstream of compressor 202. This is due to the fact that pumping a liquid fuel to a high pressure generally takes less power than compressing a gaseous fuel to a high pressure. Both can be accomplished, however.

The catalytic combustion system 100 offers many fuel-use advantages compared to conventional gas-turbine engines. For example, one advantage is that the catalytic combustion system 100 is capable of using any liquid fuel that can be adequately vaporized. The catalytic combustion system 100 is also more tolerant to the use of automotive type or pulse width modulation (PWM) type fuel injectors than conventional gas-turbine engines.

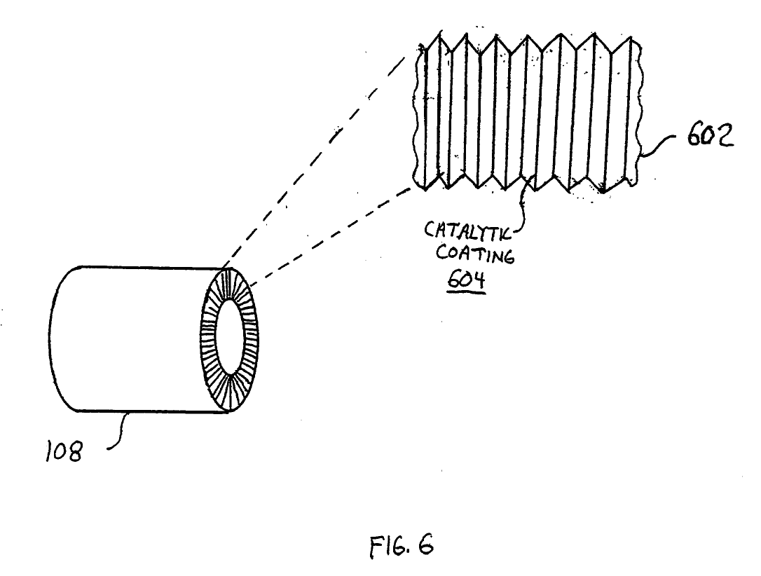

FIG. 6 illustrates catalytic reactor 108. Catalytic reactor 108 has many corrugated metal sheets 602. These metal sheets are coated with a catalytic coating 604. Catalytic reactor 108 is designed to have a relatively large surface area for oxidizing the fuel-air mixture. As noted above, catalytic reactors suitable for use in combustion system 100 are available, for example, from Süd-Chemie Prototech, Inc., 32 Fremont Street, Needham, Mass. 02494.

FIG. 7 illustrates recuperator 204 and electric band heater 702. Electric band heater 702 is one means for implementing the function of pre-heater 204.

Electric band heater 702 is wrapped around recuperator 204 to take advantage of the heat transfer area of recuperator 204 and to heat the exhaust gasses and fuel-air mixture passing through recuperator 204. As noted above, this embodiment has the advantage that it does not impose an additional pressure drop that can be imposed by an electric heating element or a fuel injector when these items are placed in the exhaust flow stream to heat the exhaust gasses.

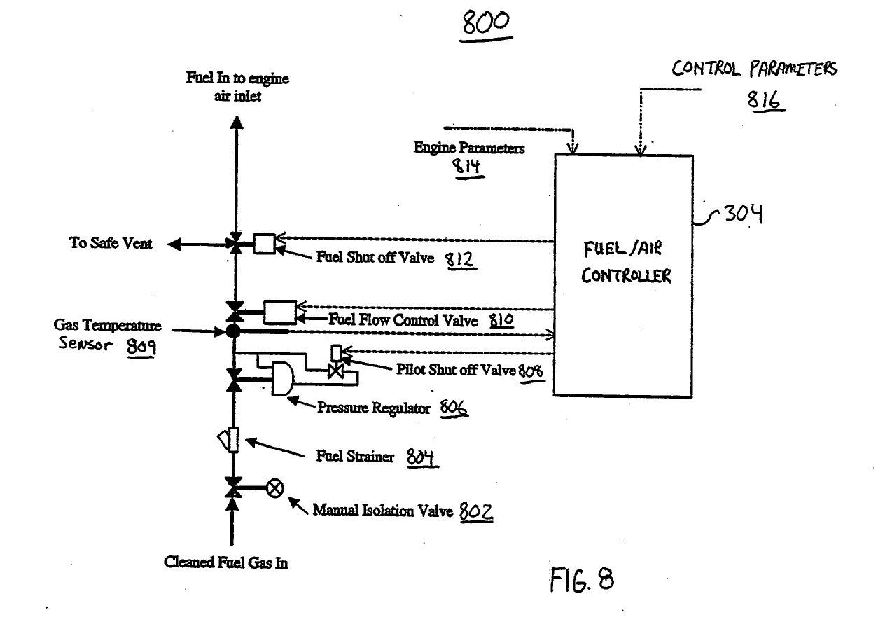

FIG. 8 is a schematic diagram of a fuel-air control system 800 according to the invention. Fuel-air control system 800 includes fuel-air controller 304, a manual isolation valve 802, a fuel strainer 804, a pressure regulator 806, a pilot shut-off valve 808, a gas temperature sensor 809, a fuel flow control valve 810, and a fuel shut-off valve 812. Pressure regulator 806 provides a stable pressure upstream of fuel flow control valve 810. Fuel flow control valve 810 adjusts fuel flow to the engine. Fuel shut off valve 812 isolates the fuel supply from the engine at shut down or in an emergency. Each of valves 806, 810 and 812 is operated by fuel-air controller 304.

As described herein, fuel-air controller 304 makes automatic adjustments to the fuel-air ratio entering catalytic reactor 108. Fuel-air controller 304 receives as inputs a temperature parameter from gas temperature sensor 809, engine parameters 814 from gas-turbine engine 102 (e.g., including turbine exhaust temperature or catalytic reactor inlet temperature), and control parameters 816 from other control systems of catalytic combustion system 100. In the embodiment illustrated in FIG. 8, the fuel-air ratio is adjusted by adjusting fuel flow injected into the inlet of compressor 202 using fuel flow control valve 810.

Example Method Embodiments of the Invention

In the description that follows, example method embodiments of the invention are presented. These example methods embodiments can be used with the example engines and systems described herein.

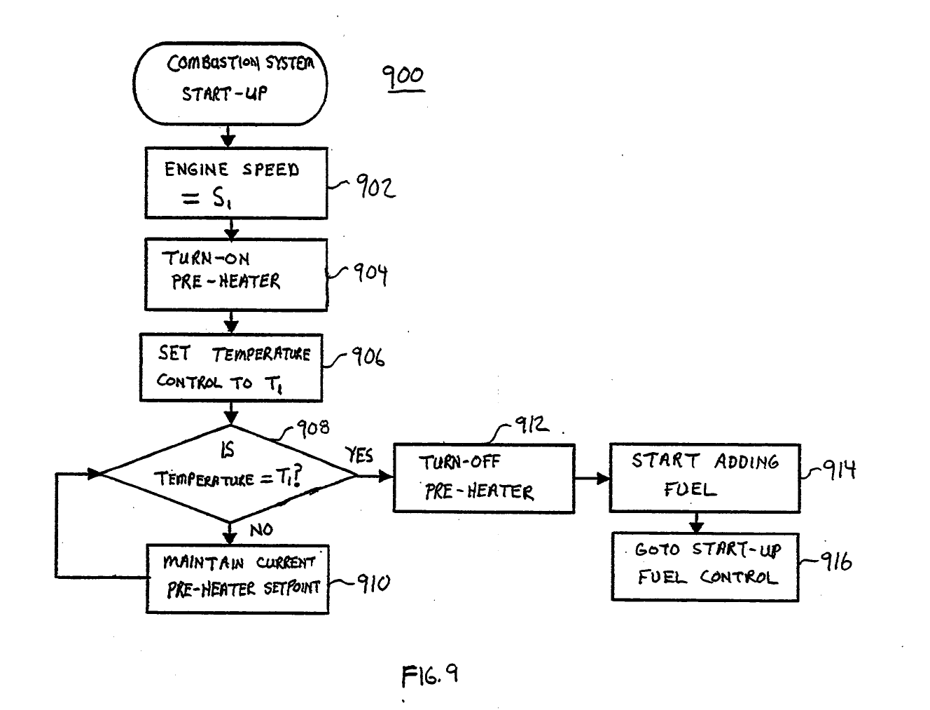

FIG. 9 is a flowchart illustrating the steps of a method 900 for starting up a catalytic combustion system. Starting up a catalytic combustion system is different than starting up a known non-catalytic combustion system. This is because a catalytic combustion system will not oxidize a fuel-air mixture until a minimum temperature is achieved within the catalyst.

Method 900 starts at step 902. In step 902, the speed of a gas-turbine engine is accelerated to a speed S₁. Speed S₁ represents a minimum speed at which the engine can be operated for a set period of time without damaging the engine. For example, in an engine having air bearings, the speed S₁ may represent the minimum speed needed for the air bearings to function.

In step 904, a pre-heater is turned on to add thermal energy to gasses being circulated through the gas-turbine engine. These circulating gasses constitute combustion air.

In step 906, a temperature control is set to a temperature T₁. Temperature T₁ is the minimum temperature needed within a catalyst to start efficient oxidation of a fuel-air mixture. Temperature T₁ may be a related temperature such as, for example, turbine exhaust temperature that can be related to the minimum temperature needed within a catalyst to start efficient oxidation of a fuel-air mixture.

In step 908, the operating temperature of the gas-turbine engine is checked to determine whether it has reached the temperature T₁ set in step 906. If the operating temperature has reached temperature T₁, control passes to step 912. Otherwise, control passes to step 910.

In step 910, the gas-turbine engine is run at speed S₁, and the pre-heater is left on to continue adding thermal energy to circulating gasses. After a selected period of time, control is passed from step 910 back to step 908.

In step 912, the pre-heater is turned off. The pre-heater is turned off because it is no longer needed to raise the temperature of any circulating gasses to temperature T₁.

In step 914, fuel is added to the circulating gasses to form a fuel-air mixture. There is a time delay from when the pre-heater is turned-off to when the fuel is added to form a fuel-air mixture. This time delay is used to ensure the pre-heater will not act as an auto ignition source for the fuel-air mixture.

In step 916, control is passed from a catalytic combustion start-up method 900 to a start-up fuel control method.

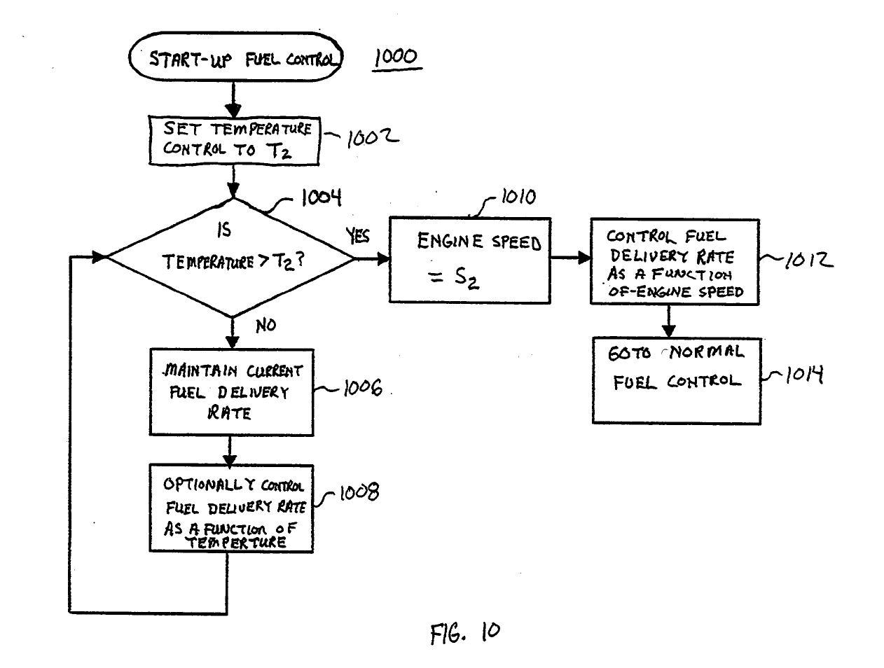

FIG. 10 is a flowchart illustrating the steps of a method 1000 for controlling the fuel delivery rate in a catalytic combustion system during start-up. Method 1000 is used to protect the catalytic combustion system against any harmful effects caused by ramping up the fuel delivery rate too quickly.

Method 1000 starts at step 1002. In step 1002, the temperature control is set to a temperature T₂. Temperature T₂ is the temperature at which the speed of the gas-turbine engine can be accelerated to a minimum speed for normal sustained operation.

In step 1004, the operating temperature of the gas-turbine engine is checked to determine whether it has reached the temperature T₂ set in step 1002. If the operating temperature has reached temperature T₂, control passes to step 1010. Otherwise, control passes to step 1006.

In step 1006, the gas-turbine engine is run at speed S₁, and the fuel delivery rate is maintained at a start-up rate. This start-up fuel delivery rate is not a function of gas-turbine engine operating temperature. After a set period of time, control is passed from step 1006 either to optional step 1008 or to step 1004.

In step 1008, the fuel delivery rate is optionally controlled as a function of engine operating temperature. If step 1008 is employed, the start-up fuel delivery rate is increased in step 1008 as a function of operating temperature in order to reduce the start-up time of the catalytic combustion system. After a set period of time, control is passed from step 1008 to 1004.

In step 1010, the speed of the gas-turbine engine is increased to a speed S₂. The speed S₂ is the minimum speed necessary for normal sustained operation of the gas-turbine engine.

In step 1012, fuel delivery control is changed so that the fuel delivery rate is controlled as a function of gas-turbine engine speed. Thus, as the speed of the gas turbine engine increases due to an increase in demanded power, the fuel delivery rate increases to maintain a constant or nearly constant operating temperature. Conversely, as the speed of the gas turbine engine decreases due to a decrease in demanded power, the fuel delivery rate decreases to maintain a constant or nearly constant operating temperature.

In step 1014, control passes from method 1000 to a method for normal fuel control. A normal fuel control method is needed after start-up to change the control gains to those needed to accommodate the response time of the catalytic reactor and to incorporate any delays needed to account for normal operating system response times.

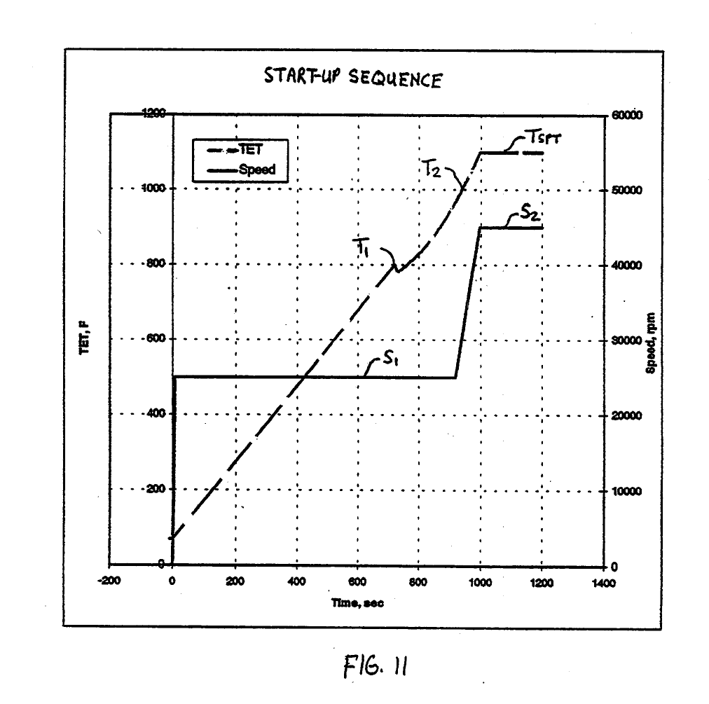

FIG. 11 is a graph illustrating an example start-up sequence for a catalytic combustion system according to the invention. FIG. 11 illustrates the operation of method 900 and method 1000.

At time 0 seconds, the gas-turbine engine is accelerated from a speed of 0 rpm to a speed of 25,000 rpm (i.e., speed S₁). The pre-heater is turned on, and it starts adding thermal energy to the system (circulating gasses).

At approximately 725 seconds, the operating temperature of the system (turbine exhaust temperature (TET)) has reached 800° F. (temperature T₁), and the pre-heater is turned off. When the pre-heater is turned off, the operating temperature of the engine initially drops, but then quickly recovers and continues to rise as heat is released by the oxidation of fuel.

At approximately 925 seconds, the operating temperature of the system (TET) has reached 1000° F. (temperature T₂), and the gas-turbine engine is starting to accelerate from a speed of 25,000 rpm to a speed of 45,000 rpm (i.e., speed S₂). The means of controlling fuel delivery rate is changed so that the rate of fuel delivery is controlled as a function of gas-turbine engine speed. Thus, as the engine accelerates, so does the fuel delivery rate. In turn, the operating temperature of the gas-turbine engine also rises.

At 1000 seconds, both the engine speed and the engine operating temperature have reached their respective set points (i.e., 45,000 rpm and 1100° F. Other set points are used in other embodiments. Thus, these values are not to be used to limit the invention.

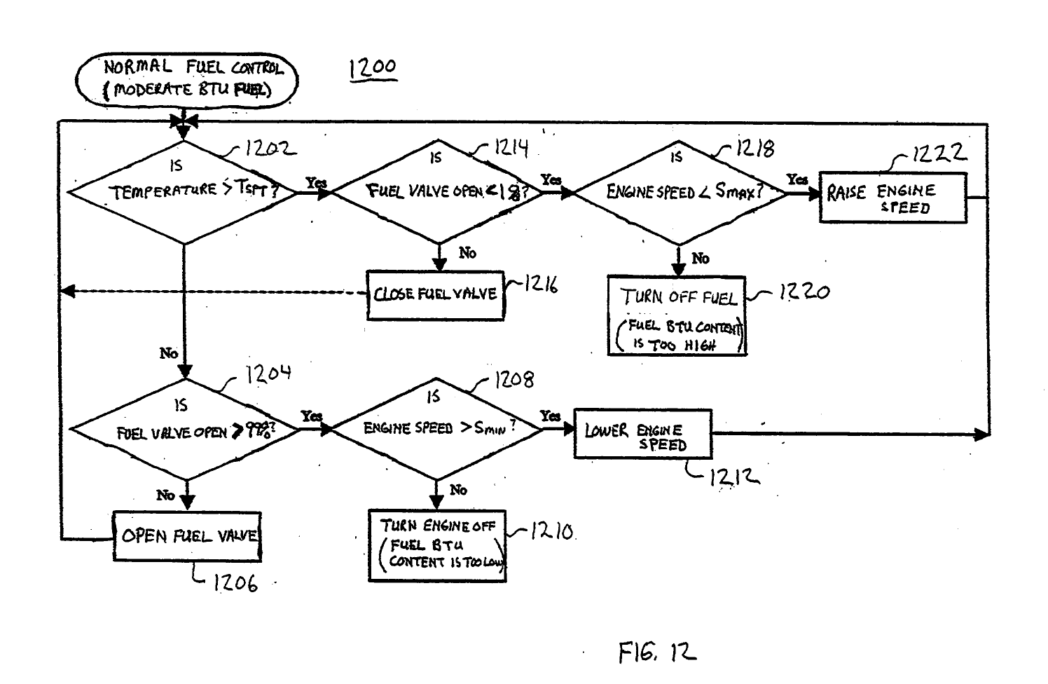

FIG. 12 is a flowchart illustrating the steps of a method 1200 for normal fuel control in a moderate BTU fuel catalytic combustion system according to the invention. Moderate BTU fuel mixtures typically contain between 1000 and 100 BTU/scf. (See commonly owned U.S. patent application Ser. No. 10/303,051, filed Nov. 25, 2002, which is incorporated herein by reference in its entirety, for a description of a non-catalytic combustion system capable of utilizing moderate BTU fuel mixtures.)

Method 1200 starts at step 1202. In step 1202, the operating temperature of the gas-turbine engine is checked to determine whether it is greater than a set point temperature, T_{SPT}. If the operating temperature is greater than T_{SPT}, control passes to step 1214. Otherwise, control passes to step 1204. A dead-band is typically employed around the set point temperature T_{SPT} to stabilize any controls used to implement the method 1200.

In step 1204, the position of the fuel valve supplying fuel to the gas-turbine engine is checked to determine whether it is greater than 99% open. If the fuel valve is greater than 99% open, control passes to step 1208. Otherwise, control passes to step 1206.

In step 1206, the fuel valve is opened by a selected amount in an attempt to raise the operating temperature of the catalytic combustion system. Opening the fuel valve increases the rate at which fuel is delivered to the catalytic reactor, and it increases the amount of thermal energy produced by the catalytic reactor.

In step 1208, the operating speed of the gas-turbine engine is checked to determine whether it is greater than a minimum set point speed, S_{MIN}. If the operating speed is greater than S_{MIN}, control passes to step 1212. Otherwise, control passes to step 1210.

In step 1210, the gas-turbine engine is turned off or shut down. Control is passed to step 1210 only if the thermal content of the fuel being used is too low for proper operation of the gas-turbine engine.

In step 1212, the speed of the gas turbine engine is lowered in an attempt to raise the operating temperature of the gas-turbine engine. In step 1212, the speed is never lowered below the speed SMIN. After the engine speed is lowered, control is returned to step 1202.

In step 1214, the position of the fuel valve supplying fuel to the gas-turbine engine is checked to determine whether it is less than 1% open. If the fuel valve is less than 1% open, control passes to step 1218. Otherwise, control passes to step 1216.

In step 1216, the fuel valve is closed by a selected amount in an attempt to lower the operating temperature of the catalytic combustion system. Closing the fuel valve decreases the rate at which fuel is delivered to the catalytic reactor, and it decreases the amount of thermal energy produced by the catalytic reactor.

In step 1218, the operating speed of the gas-turbine engine is checked to determine whether it is less than a maximum set point speed, S_{MAX}. If the operating speed is less than S_{MAX}, control passes to step 1222. Otherwise, control passes to step 1220.

In step 1220, the fuel is turned off or the engine is throttled. Control is passed to step 1220 only if the thermal content of the fuel being used is too high for proper operation of the gas-turbine engine.

In step 1222, the speed of the gas turbine engine is raised in an attempt to lower the operating temperature of the gas-turbine engine. In step 1222, the speed is never raised above the speed S_{MAX}. After the engine speed is raised, control is returned to step 1202.

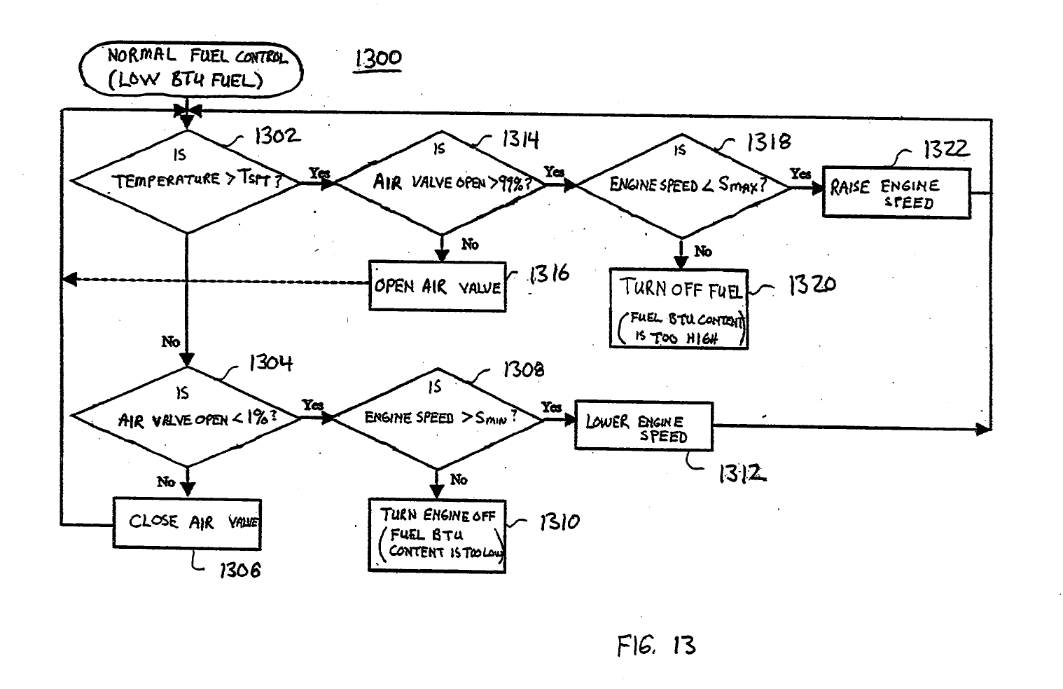

FIG. 13 is a flowchart illustrating the steps of a method 1300 for normal fuel control in a low BTU fuel catalytic combustion system. Low BTU fuels have a higher heating value of between 100 and 30 BTU/scf. Low BTU fuel mixtures contain, for example, 15000 ppm CH₄ (1.5% CH₄) or 2.5% CO/2.5% H₂. The remaining content is air. In such embodiments, the fuel concentration is so low that fresh air flow rather than fuel flow into the engine should to be controlled.

Method 1300 starts at step 1302. In step 1302, the operating temperature of the gas-turbine engine is checked to determine whether it is greater than a set point temperature, T_{SPT}. If the operating temperature is greater than T_{SPT}, control passes to step 1314. Otherwise, control passes to step 1304.

In step 1304, the position of the air valve 205 supplying air to the gas-turbine engine is checked to determine whether it is less than 1% open. If the air valve is less than 1% open, control passes to step 1308. Otherwise, control passes to step 1306.

In step 1306, the air valve is closed by a selected amount in an attempt to increase the operating temperature of the gas-turbine engine. Closing the air valve increases the fuel-air ratio of the fuel-air mixture being oxidized by the catalytic reactor, and it increases the amount of thermal energy being produced by the catalytic reactor.

In step 1308, the operating speed of the gas-turbine engine is checked to determine whether it is greater than a minimum set point speed, S_{MIN}. If the operating speed is greater than S_{MIN}, control passes to step 1312. Otherwise, control passes to step 1310.

In step 1310, the gas-turbine engine is turned off or shut down. Control is passed to step 1310 only if the thermal content of the fuel being used is too low for proper operation of the gas-turbine engine.

In step 1312, the speed of the gas turbine engine is lowered in an attempt to raise the operating temperature of the gas-turbine engine. In step 1312, the speed is never lowered below the speed S_{MIN}. After the engine speed is lowered, control is returned to step 1302.

In step 1314, the position of the air valve supplying air to the gas-turbine engine is checked to determine whether it is greater than 99% open. If the air valve is greater than 99% open, control passes to step 1318. Otherwise, control passes to step 1316.

In step 1316, the air valve is opened by a selected amount in an attempt to lower the operating temperature of the catalytic combustion system. Opening the air valve dilutes the fuel in the fuel-air mixture and reduces the fuel-air ratio of the mixture being injected into the gas-turbine engine.

In step 1318, the operating speed of the gas-turbine engine is checked to determine whether it is less than a maximum set point speed, S_{MAX}. If the operating speed is lower than S_{MAX}, control passes to step 1322. Otherwise, control passes to step 1320.

In step 1320, the fuel is turned off or the engine is throttled. Control is passed to step 1320 only if the thermal content of the fuel being used is too high for proper operation of the gas-turbine engine.

In step 1322, the speed of the gas turbine engine is raised in an attempt to lower the operating temperature of the gas-turbine engine. By increasing the flow of air through the catalytic combustion system without significantly increasing the rate of fuel flow, the operating temperature will decrease. In step 1322, the speed is never raised above the speed S_{MAX}. After the engine speed is raised, control is returned to step 1302.

As described herein, the method 1300 is particularly useful for low BTU fuel-air mixture that can be introduced at the gas turbine engine compressor inlet upstream of the air filter and filtered using a production air induction system. In these embodiments, the fuel content in the air flow can vary and thus should be measured or monitored in a manner similar to the one described below.

The present invention can also be used in an ultra low BTU fuel source environment. In some applications such as, for example, a dairy barn, the methane content of the air inside the building may be high enough to sustain engine operation (e.g., the air inside the building has a BTU content on the order of 5-30 BTU/scf). In this case, fresh air from outside of the building may have to be ducted to the air control system. The air control system will have components similar to those found in a fuel control system (e.g., fuel control system 800) except that the control software will be modified to open the air valve when less fuel is needed and to close the air valve when more fuel is needed. In order to prevent engine over-speed, there should be a shutoff valve in the piping system used to deliver the fuel-air mixture to the gas-turbine engine.

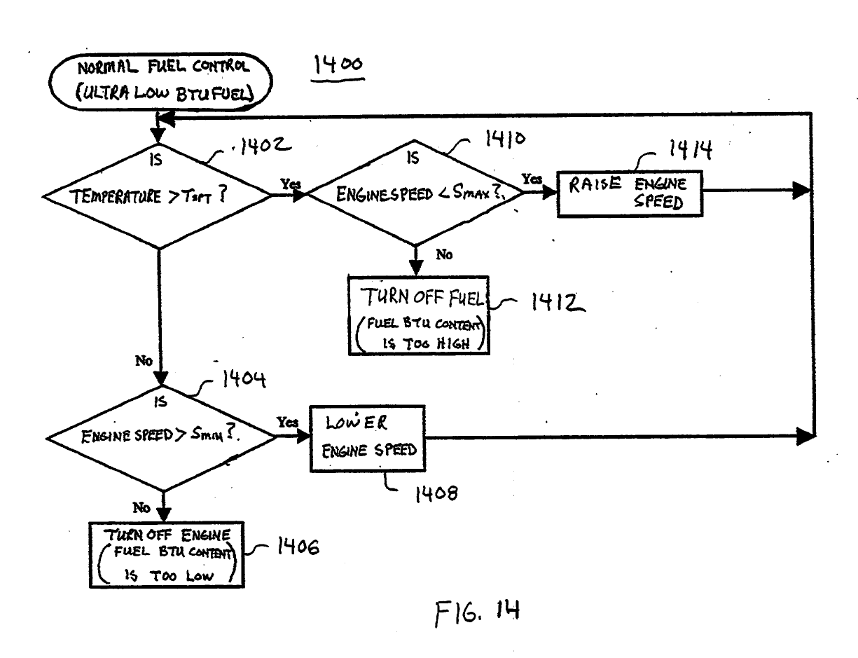

FIG. 14 is a flowchart illustrating the steps of a method 1400 for normal fuel control in an ultra low BTU catalytic combustion system. Method 1400 is intended for use in a combustion system without a fuel control valve and without an air control valve.

Method 1400 starts at step 1402. In step 1402, the operating temperature of the gas-turbine engine is checked to determine whether it is greater than a set point temperature, T_{SPT}. If the operating temperature is greater than T_{SPT}, control passes to step 1410. Otherwise, control passes to step 1404.

In step 1404, the operating speed of the gas-turbine engine is checked to determine whether it is greater than a minimum set point speed, S_{MIN}. If the operating speed is greater than S_{MIN}, control passes to step 1408. Otherwise, control passes to step 1406.

In step 1406, the gas-turbine engine is turned off or shut down. Control is passed to step 1406 only if the thermal content of the fuel being used is too low for proper operation of the gas-turbine engine.

In step 1408, the speed of the gas turbine engine is lowered in an attempt to raise the operating temperature of the gas-turbine engine. In step 1408, the speed is never lowered below the speed S_{MIN}. After the engine speed is lowered, control is returned to step 1402.

In step 1410, the operating speed of the gas-turbine engine is checked to determine whether it is less than a maximum set point speed, S_{MAX}. If the operating speed is lower than S_{MAX}, control passes to step 1414. Otherwise, control passes to step 1412.

In step 1412, the fuel is turned off or the engine is throttled. Control is passed to step 1412 only if the thermal content of the fiuel being used is too high for proper operation of the gas-turbine engine.

In step 1414, the speed of the gas turbine engine is raised in an attempt to lower the operating temperature of the gas-turbine engine. In step 1408, the speed is never raised above the speed S_{MAX}. After the engine speed is raised, control is returned to step 1402.

Method 1400 can be thought of as a method for controlling air flow into the gas-turbine engine without using an air control valve. Air flow is controlled using a fixed orifice. In certain ultra low BTU applications (e.g., when the fuel is an air-methane mixture and the methane concentration is between 1.0 and 1.35%), it is possible to operate the fuel system of a catalytic combustion system according to the invention without a control valve. The engine is controlled in these embodiments using parameters such as engine speed and engine operating temperature (e.g., turbine exhaust temperature). Eliminating the flow control valve reduces the cost of the fuel system, and it simplifies the required hardware.

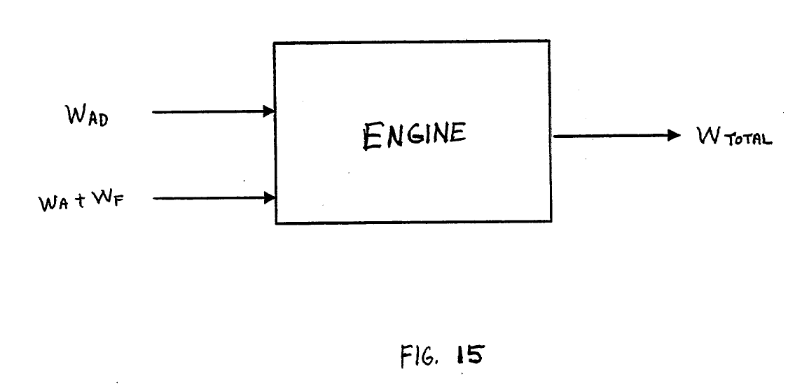

As described herein, in certain embodiments of the invention, the fuel content in the fuel-air mixture can vary and thus should be measured or monitored. FIG. 15 is a block diagram illustrating how to calculate fuel concentration for a low BTU fuel combustion system having an air flow control valve. This method can be adjusted, however, and used for other BTU fuel combustion systems having a fuel flow control valve rather than an air flow control valve.

As illustrated in FIG. 15, the total air flow through an engine (W_{TOTAL}) is a function of the air flow (W_{AD}) from an air flow control valve and the air flow (W_{A}) and the fuel flow (W_{F}) that make up the low BTU fuel mixture supplied to the engine (W_{A}+W_{F}). The total air flow (W_{TOTAL}) is a function of the rotational speed (N) of the engine and the operating temperature of the engine (e.g., turbine exhaust temperature (TET)). This function (EQ. 1) can be determined experimentally by recording W_{TOTAL} for various values of N and TET.

W_{TOTAL}=W_{AD}+(W_{F}+W_{A})=f(N,TET) EQ. 1

The operating temperature of the engine (e.g., turbine exhaust temperature (TET)) is also a function of the rotational speed (N) of the engine and the fuel-air ratio (F/A) being oxidized by the engine. By measuring the operating temperature of the engine (e.g., TET) for various fuel-air ratios and various engine speeds, a plot can be created that gives the fuel-air ratio being oxidized by the engine as a function of N and TET. This function (EQ. 2) can be determined experimentally by recording TET for various values of N and F/A.

F/A=W_{F/}(W_{AD}+W_{A})=f(N, TET) EQ. 2

By rearranging and combining EQ. 1 and EQ. 2, it can be seen that the amount of fuel present in the low BTU fuel is:

W_{F}=(W_{TOTAL}F/A)/(1−(F/A)) EQ. 3

Because WTOTAL and F/A are functions of engine speed (N) and engine operating temperature (e.g., TET), which can be determined experimentally and recorded in the form of maps or graphs, the fuel flow (WF) during engine operation can be determined using EQ. 3 and the maps or graphs created for WTOTAL and F/A.

The functionality of the catalyst in the catalytic reactor 108 is checked or tested on a periodic basis (e.g., on a weekly basis). The functionality of the catalyst can be used to determine when the catalyst has reached the end of its useful operating life. Data obtained during this periodic check or test is stored in a memory so that is can be used for subsequent analysis and diagnostic evaluations. The check or test involves determining the time needed to return to an expected operating temperature following a change in fuel delivery rate or a change in output power level.

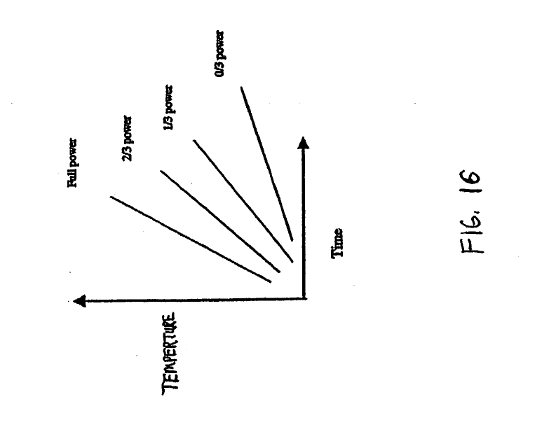

FIG. 16 is a graph illustrating temperature rise as a function of time and power level for a combustion system.

An old catalytic reactor is replaced with a new catalytic reactor whenever the old catalytic reactor has reached the end of its useful operating life. A catalytic reactor can be said to have reached the end of its useful operating life, for example, if it has operated for a specified number of hours, if the gas-turbine engine can no longer operate at full speed using a particular fuel-air ratio, or if unburned hydrocarbon levels exceed a specified threshold level.

The functionality of the catalyst is characterized by a functionality value. For example, a functionality value relating to a heat-up rate of the combustion system (temperature rise time) is used to characterize the functionality of the catalyst. This functionality value can be derived using the following test. First, operate the combustion system so that it is. supplying a known power level to a utility grid (e.g., 10 kW). Next, reduce the operating temperature set point of the combustion system by a selected amount (e.g., 50° F.). Open the fuel valve to a particular percent open setting (e.g., 40% open). Measure the time it takes the combustion system to return to the normal operating temperature (e.g., TET) set point. An older catalyst or a catalyst reaching the end of its useful operating life will take longer to get to the normal operating temperature set point. The measured time it takes the combustion system to return to the normal operating temperature (e.g., TET) set point can be stored and used to trend the functionality of the combustion system over time using, for example, exponential or linear averaging.

A reaction detection algorithm is used to eliminate any need for a catalyst temperature sensor and to improve the robustness of controller software algorithms. The reaction detection algorithm is incorporated into the logic of temperature controller 328. The reaction detection algorithm is used to operate pre-heater 208.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A catalytic combustion system, comprising:
a catalytic reactor that ingests fuel and combustion air to generate thermal energy, the amount of ingested combustion air being sufficient to fully oxidize the ingested fuel; and
a variable speed turbine fluidly coupled to the catalytic reactor that converts the thermal energy into mechanical energy.

2. The system of claim 1, wherein said catalytic reactor is capable of oxidizing a fuel having a higher heating value of less than 750 BTU/scf.

3. The system of claim 1, wherein said catalytic reactor is capable of oxidizing a fuel having a higher heating value of less than 100 BTU/scf.

4. The system of claim 1, wherein said catalytic reactor is capable of oxidizing a fuel having a higher heating value of less than 30 BTU/scf.

5. The system of claim 1, further comprising:
a motor-generator mechanically coupled to said turbine;
a bi-directional power converter electrically coupled between said motor-generator and a DC bus; and
a power-flow control system, coupled to said bi-directional power converter, to control the flow of power between said motor-generator and the DC bus.

6. The system of claim 1, further comprising:
a compressor fluidly coupled to said catalytic reactor.

7. The system of claim 6, further comprising:
a fuel mixer, fluidly coupled to said compressor, for mixing fuel with combustion air to form a fuel-air mixture having a peak fuel concentration at an exit of a mixing zone that is below an explosive limit of the fuel.

8. The system of claim 7, wherein the catalytic combustion system further comprises a generator winding, a bearing, and a compressor shroud, and wherein a peak fuel concentration that comes into contact with at least one of said generator winding, said bearing, and said compressor shroud is below a flammability limit of the fuel.

9. The system of claim 7, wherein said fuel mixer has a geometry that prevents more than an insubstantial amount of fuel from entering a flow streamline used for extracting bleed air downstream of said mixing zone.

10. The system of claim 7, further comprising:
a pre-heater for adding thermal energy to the fuel-air mixture prior to oxidation by said catalytic reactor.

11. The system of claim 10, wherein said pre-heater includes an electrical heating element.

12. The system of claim 11, wherein said electrical heating element is powered by excess energy produced by the catalytic combustion system.

13. The system of claim 10, wherein said pre-heater includes a fuel oxidation heating element.

14. The system of claim 10, wherein said pre-heater is in thermal contact with said catalytic reactor.

15. The system of claim 10, further comprising:
a recuperator fluidly coupled to said turbine for adding energy to the fuel-air mixture prior to oxidation by said catalytic reactor.

16. The system of claim 15, wherein said pre-heater is in thermal contact with a surface of said recuperator.

17. The system of claim 15, wherein said pre-heater is disposed to heat exhaust gasses of said turbine.

18. The system of claim 15, wherein said pre-heater is disposed to heat inlet gasses of said turbine.

19. The system of claim 1, further comprising:
a control system electrically coupled to the catalytic combustion system to vary a fuel-air mixture ingested by said catalytic reactor and thereby control a temperature of the catalytic combustion system.

20. The system of claim 1, further comprising:
a control system electrically coupled to the catalytic combustion system to vary a rotational speed of said turbine and thereby control a temperature of the catalytic combustion system.

21. A catalytic combustion system, comprising:
a catalytic reactor that substantially fully oxidizes at least sixty percent of all fuel consumed by the catalytic combustion system to generate thermal energy; and
a variable speed turbine fluidly coupled to said catalytic reactor that converts the thermal energy into mechanical energy.

22. The system of claim 21, further comprising:
a motor-generator mechanically coupled to said turbine;
a bi-directional power converter electrically coupled between said motor-generator and a DC bus; and
a power-flow control system coupled to said bi-directional power converter to control the flow of power between said motor-generator and the DC bus.

23. The system of claim 21, further comprising:
a compressor fluidly coupled to said catalytic reactor.

24. The system of claim 23, further comprising:
a fuel mixer, fluidly coupled to said compressor, for mixing fuel with combustion air to form a fuel-air mixture having a peak fuel concentration at an exit of a mixing zone that is below an explosive limit of the fuel.

25. The system of claim 24, further comprising:
a pre-heater for adding thermal energy to the fuel-air mixture.

26. The system of claim 25, wherein said pre-heater is disposed to heat exhaust gasses of said turbine.

27. The system of claim 25, wherein said pre-heater is disposed to heat inlet gasses of said turbine.

28. The system of claim 24, further comprising:
a recuperator fluidly coupled to said turbine for adding energy to the fuel-air mixture prior to oxidation by said catalytic reactor.

29. The system of claim 24, wherein the catalytic combustion system further comprises a generator winding, a bearing, and a compressor shroud, and wherein a peak fuel concentration that comes into contact with at least one of said generator winding, said bearing, and said compressor shroud is below a flammability limit of the fuel.

30. The system of claim 24, wherein said fuel mixer has a geometry that prevents more than an insubstantial amount of fuel from entering a flow streamline used for extracting bleed air downstream of said mixing zone.

31. The system of claim 21, further comprising:
a control system electrically coupled to the catalytic combustion system for varying a fuel-air mixture ingested by said catalytic reactor to control a temperature of the catalytic combustion system.

32. The system of claim 21, further comprising:
a control system electrically coupled to the catalytic combustion system for varying a rotational speed of said turbine to control a temperature of the catalytic combustion system.

33. A catalytic combustion system, comprising:
a catalytic reactor for substantially fully oxidizing at least sixty percent of all fuel consumed by the catalytic combustion system to generate thermal energy;
a turbine fluidly coupled to said catalytic reactor for converting at least a portion of the thermal energy into mechanical energy;
a motor-generator mechanically coupled to said turbine;
a bi-directional power converter electrically coupled between said motor-generator and a DC bus;
a power-flow control system coupled to said bidirectional power converter to control the flow of power between said motor-generator and the DC bus;
a compressor fluidly coupled to said catalytic reactor;
a fuel mixer fluidly coupled to said compressor for mixing fuel with air to form a fuel-air mixture; and
a recuperator fluidly coupled to said turbine for adding energy to the fuel-air mixture prior to oxidation by said catalytic reactor.

34. The system of claim 33, further comprising:
a pre-heater for adding thermal energy to the fuel-air mixture, said pre-heater being thermally coupled, by said recuperator, to an inlet of said catalytic reactor.

35. The system of claim 34, wherein said pre-heater includes an electrical heating element powered by excess energy produced by the catalytic combustion system.

36. The system of claim 34, wherein said pre-heater is disposed to heat exhaust gasses of said turbine.

37. The system of claim 34, wherein said pre-heater is disposed to heat inlet gasses of said turbine.

38. The system of claim 34, wherein said pre-heater is disposed downstream of said catalytic reactor and upstream of said turbine.

39. The system of claim 33, further comprising:
a control system electrically coupled to the catalytic combustion system to vary the fuel-air mixture ingested by said catalytic reactor and thereby control a temperature of the catalytic combustion system.

40. The system of claim 33, further comprising:
a control system electrically coupled to the catalytic combustion system to vary a rotational speed of said turbine and thereby control a temperature of the catalytic combustion system.

41. The system of claim 40, wherein the catalytic combustion system further comprises a generator winding, a bearing, and a compressor shroud, and wherein a peak fuel concentration that comes into contact with at least one of said generator winding, said bearing, and said compressor shroud is below a flammability limit of the fuel.

42. The system of claim 40, wherein said fuel mixer has a geometry that prevents more than an insubstantial amount of fuel from entering a flow streamline used for extracting bleed air downstream of said compressor.
